(19) United States
(12) Patent Application Publication
(10) Pub. No.: US 2020/0387724 A1
(43) Pub. Date: Dec. 10, 2020

(54) DRIVER STATE DETECTION DEVICE

(71) Applicant: HONDA MOTOR CO., LTD., Tokyo (JP)

(72) Inventors: Masaki Maruyama, Wako-shi (JP); Minoru Higuchi, Wako-shi (JP); Shinichi Murakami, Wako-shi (JP); Toshihiro Hashimoto, Wako-shi (JP)

(21) Appl. No.: 16/884,083

(22) Filed: May 27, 2020

(30) Foreign Application Priority Data
Jun. 7, 2019 (JP) 2019-107396

(51) Int. Cl. G06K 9/00; B60W 40/08; B60K 35/00

(52) U.S. Cl. CPC G06K 9/00845; G06K 9/00604; B60W 40/08; B60K 2370/176; B60W 2540/225; B60W 2420/403; B60K 2370/152; B60K 35/00

(57) ABSTRACT

A driver state detection device includes at least two state detection units that include a first state detection unit and a second state detection unit that detect a state of a driver of a vehicle, in which the first state detection unit and the second state detection unit are disposed at positions between which the driver is interposed in a vehicle width direction, and the first state detection unit and the second state detection unit are disposed in front of a rear end of a driver's seat.

### CROSS-REFERENCE TO RELATED APPLICATION

Priority is claimed on Japanese Patent Application No. 2019-107396, filed on Jun. 7, 2019, the contents of which are incorporated herein by reference.

### BACKGROUND

### Field of the Invention

The present invention relates to a driver state detection device.

### Background

In recent years, for the introduction of advanced safety support systems and automatic driving systems involving an accelerator, a brake, and a steering control of a vehicle, a device that detects and confirms the line-of-sight direction of a driver has been provided in front of the driver in the vehicle (for example, refer to PCT International Publication No. WO 2014/188648).

### SUMMARY

However, in the conventional driver state detection device, if the line-of-sight direction of the driver is facing in directions over a wide angle that form a relatively large angle on the basis of the driver viewpoint in a top view, the detection accuracy of the line-of-sight direction of the driver may decrease in some cases. For example, in the conventional driver state detection device, it may not be possible to detect with high accuracy that the line of sight of the driver is facing a side mirror.

Aspects of the present invention provide a driver state detection device capable of detecting a line-of-sight direction of a driver with a wide angle and with high accuracy.

A driver state detection device according to a first aspect of the present invention includes at least two state detection units that include a first state detection unit and a second state detection unit that detect a state of a driver of a vehicle, in which the first state detection unit and the second state detection unit are disposed at positions between which the driver is interposed in a vehicle width direction, and the first state detection unit and the second state detection unit are disposed in front of a rear end of a driver's seat.

According to a second aspect of the present invention, in the driver state detection device according to the first aspect described above, the state detection units may be at least two line-of-sight detection units that include a first line-of-sight detection unit and a second line-of-sight detection unit that detect a line-of-sight direction of the driver.

According to a third aspect of the present invention, in the driver state detection device according to the second aspect described above, the first line-of-sight detection unit and the second line-of-sight detection unit may be disposed in front of a steering wheel.

According to a fourth aspect of the present invention, the driver state detection device according to the second or third aspect described above may include an estimation unit configured to estimate the line-of-sight direction of the driver based on a detection result of the line-of-sight detection unit.

According to a fifth aspect of the present invention, in the driver state detection device according to any one of the second to fourth aspects described above, in the vehicle, a window frame may be disposed on a side of the driver, a mirror may be disposed on an outer side of the window frame in the vehicle width direction, and a front pillar extending in a vehicle body vertical direction may be disposed in front of the window frame, and the first line-of-sight detection unit may be disposed on the front pillar.

According to a sixth aspect of the present invention, in the driver state detection device according to any one of the second to fifth aspects described above, the vehicle may include a driver's seat on which the driver is seated and a passenger seat disposed on a side of the driver's seat, and the second line-of-sight detection unit may be disposed at a position closer to the passenger seat side than a steering wheel in the vehicle width direction.

According to a seventh aspect of the present invention, in the driver state detection device according to any one of the second to sixth aspects described above, the vehicle may include a display unit configured to display a preference image, a situation of an interior space of the vehicle, or a situation of surroundings of the vehicle, and the second line-of-sight detection unit may be provided around the display unit.

According to an eighth aspect of the present invention, in the driver state detection device according to the seventh aspect described above, the display unit may be disposed between the driver's seat and the passenger seat in the vehicle width direction.

According to a ninth aspect of the present invention, in the driver state detection device according to any one of the second to eighth aspects described above, a first angle formed of a first line connecting a center of the first line-of-sight detection unit and a viewpoint position of the driver and a second line connecting a center of the second line-of-sight detection unit and the viewpoint position in a top view may be equal to or less than 70°.

According to a tenth aspect of the present invention, in the driver state detection device according to the ninth aspect described above, the first angle may be equal to or more than 60°.

According to an eleventh aspect of the present invention, in the driver state detection device according to the ninth or tenth aspect described above, a second angle, which is formed of the first line centered on the viewpoint position and a center line extending in a vehicle body longitudinal direction through the viewpoint position in the top view, and a third angle, which is formed of the second line and the center line in the top view, may be different from each other.

According to a twelfth aspect of the present invention, in the driver state detection device according to the ninth or tenth aspect described above, a second angle, which is formed of the first line centered on the viewpoint position and a center line extending in a vehicle body longitudinal direction through the viewpoint position in the top view, and a third angle, which is formed of the second line and the center line in the top view, may be equal to each other.

According to a thirteenth aspect of the present invention, in the driver state detection device according to any one of the second to twelfth aspects described above, the first line-of-sight detection unit and the second line-of-sight detection unit may be disposed to be offset in a vehicle body longitudinal direction.

According to a fourteenth aspect of the present invention, in the driver state detection device according to any one of the sixth to thirteenth aspects described above, a passenger seat airbag that is deployed at a predetermined timing may be disposed in front of the passenger seat in a vehicle body longitudinal direction, and the second line-of-sight detection unit may be disposed at a position closer to the driver side than an outermost end of the passenger seat airbag in a deployed state in the vehicle width direction.

According to a fifteenth aspect of the present invention, in the driver state detection device according to any one of the second to fourteenth aspects described above, each of the at least two line-of-sight detection units may include an irradiation unit configured to irradiate the driver with a reference point and a recognition unit configured to recognize the reference point and a part of an eyeball of the driver, in which the irradiation unit and the recognition unit may be disposed in a vehicle body vertical direction in the first line-of-sight detection unit.

According to a sixteenth aspect of the present invention, in the driver state detection device according to the fifteenth aspect described above, the irradiation unit and the recognition unit may be disposed in the vehicle width direction in the second line-of-sight detection unit.

According to a seventeenth aspect of the present invention, in the driver state detection device according to the fifteenth aspect described above, the irradiation unit and the recognition unit may be disposed in the vehicle body vertical direction in the second line-of-sight detection unit.

According to an eighteenth aspect of the present invention, in the driver state detection device according to any one of the fifteenth to seventeenth aspects described above, the recognition unit of the first line-of-sight detection unit and the recognition unit of the second line-of-sight detection unit may be disposed to be offset in the vehicle body vertical direction.

According to a nineteenth aspect of the present invention, in the driver state detection device according to the fifteenth or eighteenth aspect described above, the recognition unit of the first line-of-sight detection unit and the recognition unit of the second line-of-sight detection unit may be disposed between an upper end and a lower end of a mirror in the vehicle body vertical direction.

According to the first aspect described above, since at least the first state detection unit and the second state detection unit are disposed with the driver interposed therebetween in the top view in the vehicle width direction, it is possible to detect various states of the driver over a wide angle and with high accuracy as compared with a case in which a conventional state detection device (a line-of-sight detection device) or the like is provided at a position substantially overlapping the driver in the vehicle width direction.

According to the second aspect described above, since the line-of-sight direction is used as one of information indicating the state of the driver, and at least the first line-of-sight detection unit and the second line-of-sight detection unit are disposed with the driver interposed therebetween in the vehicle width direction in the top view, it is possible to detect the line-of-sight direction of the driver over a wide angle and with high accuracy as compared to the case in which the conventional line-of-sight detection device or the like is provided at a position substantially overlapping the driver in the vehicle width direction.

According to the third aspect described above, since at least the first line-of-sight detection unit and the second line-of-sight detection unit are disposed in front of the steering wheel, the driving operation of the driver is unlikely to be disturbed and is performed smoothly.

According to the fourth aspect described above, the detection results of the first line-of-sight detection unit and the second line-of-sight detection unit are combined or the detection result of one of the first line-of-sight detection unit and the second line-of-sight detection unit, which has higher reliability, is adopted by the estimation unit, and thereby it is possible to detect the line-of-sight direction of the driver accurately and in multiple angles as compared with a case in which the estimation unit is not provided.

According to the fifth aspect described above, it is possible to further increase the detection accuracy of whether the driver has viewed the mirror. Moreover, according to the fifth aspect, the first line-of-sight detection unit can be disposed not to protrude from the front pillar, and the wiring efficiency of the first line-of-sight detection unit can be improved.

According to the sixth aspect described above, furthermore, the line of sight of the driver is unlikely to be blocked by the steering wheel, and the line-of-sight direction can be detected with high accuracy.

According to the seventh aspect described above, furthermore, it is possible to detect with high accuracy whether the driver has viewed the display unit. Moreover, according to the seventh and eighth aspects described above, the second line-of-sight detection unit is disposed not to protrude from the support member or the like which supports the display unit, and the wiring efficiency of the second line-of-sight detection unit can be improved.

According to the eighth aspect described above, furthermore, the line of sight of the driver is unlikely to be blocked by the steering wheel, a passenger sitting in the passenger seat, or the like, and it is possible to detect the line-of-sight direction with high accuracy. Moreover, according to the eighth aspect described above, it is easier to ensure the installation space of the second line-of-sight detection unit.

According to the ninth to eleventh aspects described above, furthermore, since the detection angle range in which the first line-of-sight detection unit can detect the line-of-sight direction of the driver with high accuracy and the detection angle range of the second line-of-sight detection unit are appropriately and widely distributed in the azimuth angle direction, even if the detection range of the line-of-sight direction is in a wide angle, it is possible to detect the line-of-sight direction of the driver with high accuracy, and evenly in the azimuth angle direction.

According to the twelfth aspect described above, furthermore, since the second angle and the third angle are equal to each other, and detection visual fields and accuracies when the line-of-sight direction is acquired by the first line-of-sight detection unit and the second line-of-sight detection unit can be made substantially equal to each other in the azimuth angle direction centered on the center line, initial settings for the detection visual field and accuracy become easier.

According to the thirteenth aspect described above, furthermore, since the detection angle range of the first line-of-sight detection unit and the detection angle range of the second line-of-sight detection unit are appropriately and widely distributed in the vehicle body longitudinal direction, even if the detection range of the line-of-sight direction is in a wide angle in the vehicle body longitudinal direction, it is possible to detect the line-of-sight direction of the driver with high accuracy.

According to the fourteenth aspect described above, furthermore, even when the passenger seat airbag is deployed, the line of sight of the driver is unlikely to be blocked by the passenger seat airbag in the deployed state, and the line-of-sight direction of the driver is detected with high accuracy. In addition, according to the fourteenth aspect described above, the deployment of the airbag is unlikely to be disturbed.

According to the fifteenth aspect described above, furthermore, the relative position of the iris in the eyeball is detected by the light emitted as the reference graphic by the irradiation unit being reflected and detected by the recognition unit to recognize a part of the eyeball, and it is possible to detect the line-of-sight direction with high accuracy regardless of a direction of the face of the driver. Moreover, according to the fifteenth aspect described above, since the irradiation unit and the recognition unit of the first line-of-sight detection unit are disposed in the vehicle body vertical direction, the irradiation unit and the recognition unit of the first line-of-sight detection unit can be, for example, disposed well to fit in the front pillar.

According to the sixteenth and seventeenth aspects described above, furthermore, the irradiation unit and the recognition unit of the second line-of-sight detection unit are disposed in the vehicle width direction or the vehicle body vertical direction. For this reason, for example, in accordance with a support unit of the display unit, the shape and specifications of various members extending in the vehicle width direction in front of the steering wheel in the vehicle body longitudinal direction, constraints at the time of design, and the like, the irradiation unit and the recognition unit of the second line-of-sight detection unit can be disposed well to fit in the support unit and various members described above.

According to the eighteenth aspect described above, furthermore, since the detection angle range of the first line-of-sight detection unit and the detection angle range of the second line-of-sight detection unit are appropriately and widely distributed in the vehicle body vertical direction, even if the detection range of the line-of-sight direction is in a wide angle in the vehicle body vertical direction, it is possible to detect the line-of-sight direction of the driver with high accuracy.

According to the nineteenth aspect described above, furthermore, it is possible to improve the detection accuracy of whether the driver has viewed the mirror, and provide an appropriate driving support to the driver.

### BRIEF DESCRIPTION OF THE DRAWINGS

FIG. 1 is a plan view of an inside of a vehicle equipped with a driver's line-of-sight detection device.

FIG. 2 is a schematic diagram showing a method of calculating a direction of a line-of-sight direction in the driver's line-of-sight detection device.

FIG. 3 is a side view of the inside of the vehicle equipped with the driver's line-of-sight detection device.

FIG. 4 is a perspective view in which the inside of the vehicle equipped with the driver's line-of-sight detection device is viewed from a rear to a front in a vehicle longitudinal direction.

FIG. 5 is a diagram which shows another embodiment of a driver's line-of-sight detection device different from that in FIG. 1, and is a plan view of the inside of a vehicle equipped with the driver's line-of-sight detection device of the another embodiment.

FIG. 6 is a diagram which shows another embodiment of a driver's line-of-sight detection device different from that in FIG. 1, and is a perspective view in which the inside of the vehicle equipped with the driver's line-of-sight detection device of the another embodiment is viewed from the rear to the front in the vehicle longitudinal direction.

### DESCRIPTION OF EMBODIMENTS

Hereinafter, embodiments of a driver state detection device of the present invention will be described with reference to the drawings.

### First Embodiment

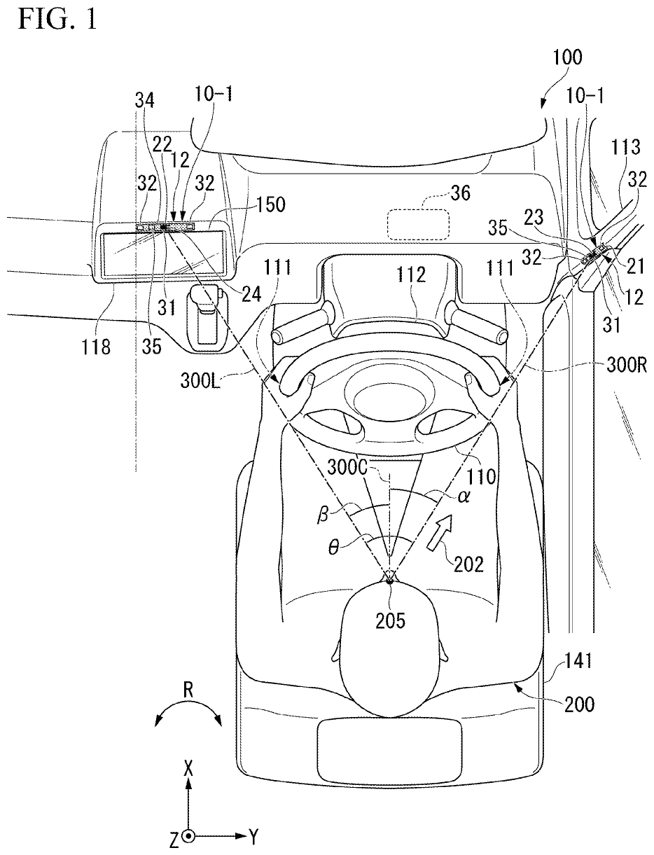

As shown in FIG. 1, a vehicle 100 is equipped with a driver's line-of-sight detection device (a driver state detection device) 10-1 according to a first embodiment of the present invention. The driver's line-of-sight detection device 10-1 includes a plurality of line-of-sight detection units 12 and an estimation unit 36. The driver's line-of-sight detection device 10-1 is a device that estimates a line-of-sight direction 202 of a driver 200 of the vehicle 100.

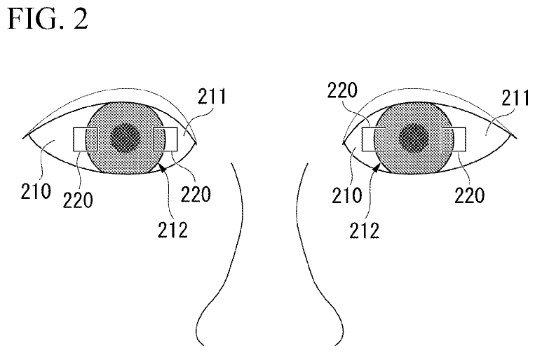

The line-of-sight direction 202 means a direction in which an iris 212 of the driver 200 is facing substantially regardless of a direction and a rotation angle of the head in a top view centered on a viewpoint position 205 of the driver 200. For example, even if the direction of the head of the driver 200 in the top view centered on the viewpoint position 205 is facing in a vehicle body longitudinal direction X, if an iris 212 (refer to FIG. 2) is viewing a diagonally to the right in front of the driver 200, the line-of-sight direction 202 is a direction that is inclined clockwise around the viewpoint position 205 with respect to a center line 300C passing through the viewpoint position 205 and extending along the vehicle body longitudinal direction X in the top view. The viewpoint position 205 is determined on the basis of, for example, the regulations (UN/ECE-R46) defined by the United Nations Economic Commission for Europe.

However, the viewpoint position 205 may be a center between both eyes of the driver 200 in a vehicle width direction Y and a vehicle body vertical direction Z in a state in which the driver 200 is seated in a driver's seat 141 to be described below, and may also be appropriately determined according to a physique of the driver 200, and a shape, specifications, and the like of the vehicle 100. A position of the head of the driver 200 may be measured by any means, and the center between both eyes of the driver 200 may be set as the viewpoint position 205.

The line-of-sight detection units (the state detection units) 12 include at least a first line-of-sight detection unit (a first state detection unit) 21 and a second line-of-sight detection unit (a second state detection unit) 22. The first line-of-sight detection unit 21 and the second line-of-sight detection unit 22 are disposed with the driver 200 interposed therebetween in the vehicle width direction Y. The first line-of-sight detection unit 21 and the second line-of-sight detection unit 22 are disposed in front of the rear end of the driver's seat 141 and, moreover, are disposed in front of a steering wheel 110 in the vehicle body longitudinal direction X.

The line-of-sight detection units 12 including the first line-of-sight detection unit 21 and the second line-of-sight detection unit 22 include two irradiation units 31 that irradiate the driver 200 with a reference graphic 220, a camera 32 that acquires the reference graphic and an image of a part of the eyeball 210 of the driver 200, and an image analysis unit 35, respectively.

The irradiation unit 31 is, for example, a light emitting diode (LED) that emits infrared rays. The irradiation unit 31 is configured to electronically, optically, or mechanically swing a direction of the radiated infrared rays in each of a direction of the yaw angle centered on the viewpoint position 205 (that is, a azimuth angle direction R), the vehicle width direction Y, and the vehicle body vertical direction Z. The camera (recognition unit) 32 is, for example, a camera capable of photographing the eyeball 210 and the reference graphic 220 with which the eyeball 210 is irradiated, and is, for example, an infrared ray camera.

When a direction in which the iris 212 is facing is detected, as shown in FIG. 2, the eyeball 210 is irradiated with a plurality of reference graphics 220 by infrared rays that cause less irritation to eyes from the irradiation unit 31.

For example, the reference graphic 220 has, for example, a rectangular shape, and the iris 212 is irradiated with two reference graphics at intervals in the vehicle direction Y.

Note that the irradiation unit 31 irradiates the head of the driver 200 with the reference graphic 220 of the infrared rays while changing the direction of the infrared rays, and positions of both eyes of the driver 200 are confirmed on the basis of the direction of the infrared rays at the time point when it is recognized that the reference graphic 220 is reflected to a head image captured by the camera 32. Instead of (or in addition to) this, a camera different from the camera 32 may be provided in the vehicle 100 to acquire the head image and to analyze the head image, and thereby the positions of both eyes of the driver 200 may be confirmed.

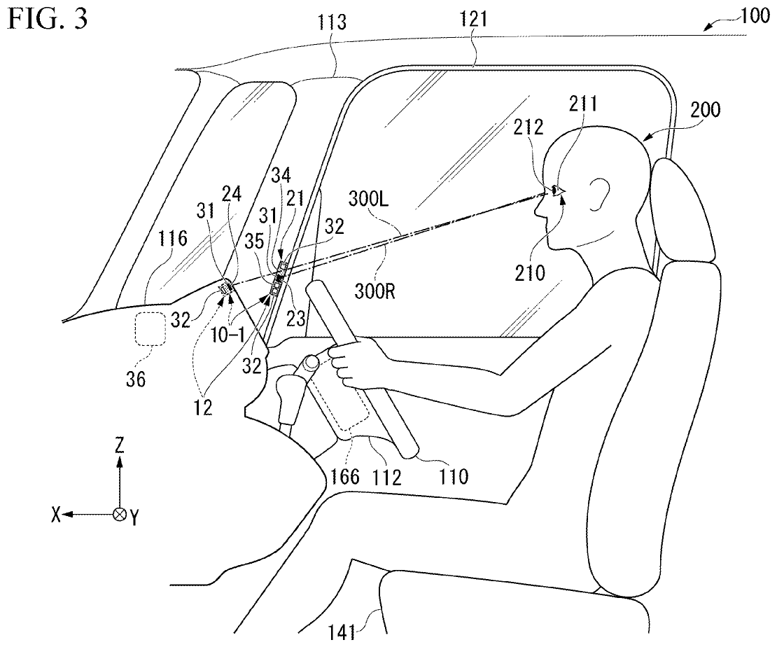

As shown in FIG. 3, the infrared rays are emitted obliquely upward from the irradiation unit 31 to rise as they move toward the eyeball 210. An elevation angle of the infrared rays with respect to a horizontal line is, for example, about 15°, and is appropriately set in consideration of performance of the camera 32 and the like. The camera 32 photographs the eyeball 210 and the reference graphic 220 reflected by the eyeball 210 as shown in FIG. 2.

The image analysis unit 35 detects a boundary position between a white eye 211 and the iris 212 by applying a predetermined algorithm based on a relative position of the irradiation unit 31 and the camera 32, a position of the eyes of the driver 200, and the like.

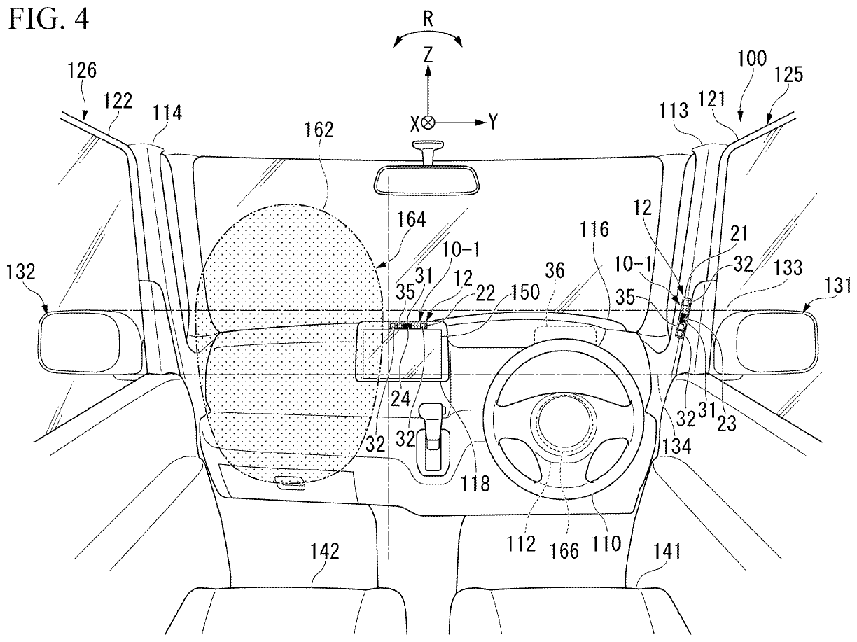

The estimation unit 36 shown in FIG. 4 estimates the line-of-sight direction 202 of the driver 200 on the basis of the boundary position between the white eye 211 and the iris 212, which is analyzed by the image analysis unit 35 of the first line-of-sight detection unit 21 and the second line-of-sight detection unit 22, respectively. Specifically, the estimation unit 36 calculates the line-of-sight direction 202 on the basis of information on the boundary position between the white eye 211 and the iris 212, a curvature of the eyeball 210 calculated from a distortion of a shape of the reference graphic 220 on the eyeball 210, and the like. The image analysis unit 35 may be embedded in the estimation unit 36.

Each of the first line-of-sight detection unit 21 and the second line-of-sight detection unit 22 includes a long support unit 34.

In the first line-of-sight detection unit 21 and the second line-of-sight detection unit 22, the irradiation unit 31 is disposed at a central portion of the support unit 34 in a longitudinal direction, and the cameras 32 are disposed at both ends of the support unit 34 in the longitudinal direction to interpose the irradiation unit 31 therebetween.

As shown in FIG. 4, the vehicle 100 is provided with doors 125 and 126 including window frames 121 and 122 on the side of the driver 200 in the vehicle width direction Y. In the vehicle width direction Y, side mirrors (mirrors) 131 and 132 are disposed on outer sides of the window frames 121 and 122. The window frames 121 and 122 and the side mirrors 131 and 132 move in conjunction with opening and closing of the doors 125 and 126.

In the vehicle body longitudinal direction X, front pillars 113 and 114 extending in the vehicle body vertical direction Z are disposed in front of the window frames 121 and 122 with the doors 125 and 126 closed. The first line-of-sight detection unit 21 is disposed in the front pillar 113. An extending direction of the first line-of-sight detection unit 21 overlaps with an extending direction of the front pillar 113. That is, in the first line-of-sight detection unit 21, the irradiation unit 31 and the two cameras 32 and 32 are disposed in the vehicle body vertical direction Z, and the camera 32, the irradiation unit 31, and the camera 32 are disposed at intervals in this order from an upper side to a lower side. Wiring (not shown) of the first line-of-sight detection unit 21 is fitted inside the front pillar 113.

The vehicle 100 includes a driver's seat 141 on which the driver 200 (not shown in FIG. 3) is seated at the time of driving, and a passenger seat 142 disposed on the side of the driver's seat 141 in the vehicle width direction Y. The second line-of-sight detection unit 22 is disposed at a position closer to the passenger seat 142 than the steering wheel 110 in the vehicle width direction Y.

The vehicle 100 includes a display unit 150 that displays a preference image, a situation inside the vehicle (an interior space of the vehicle 100), or a situation of the surroundings (around the vehicle). The display unit 150 is, for example, a car navigation system or a display for a vehicle TV. The display unit 150 is disposed between the driver's seat 141 and the passenger seat 142 in the vehicle width direction Y, at a rearmost portion of a dashboard 116 of the vehicle 100 in the vehicle body longitudinal direction X, and above a center of the steering wheel 110 and below the eyeball 210 in the vehicle body vertical direction Z. The display unit 150 is supported by a support unit 118 provided integrally with the dashboard 116.

The support unit 118 is exposed on an outer periphery of the display unit 150 adjacent to the rectangular display unit 150. As shown in FIGS. 1 and 3, the second line-of-sight detection unit 22 is provided in the support unit 118 adjacent to the upper end edge of the display unit 150 when viewed in the vehicle body longitudinal direction X. That is, the second line-of-sight detection unit 22 is provided around the display unit 150. In the second line-of-sight detection unit 22, the irradiation unit 31 and the two cameras 32 and 32 are disposed in the vehicle width direction Y, and the camera 32, the irradiation unit 31, and the camera 32 are disposed at intervals in this order from one of the right side and the left side to the other. Wiring (not shown) of the second line-of-sight detection unit 22 is fitted inside the dashboard 116.

As shown in FIG. 1, an angle (a first angle) θ formed in the top view by a first line 300R connecting a center 23 of the first line-of-sight detection unit 21 and the viewpoint position 205 and a second line 300L connecting a center 24 of the second line-of-sight detection unit 22 and the viewpoint position 205 is preferably 70° or less, and can be more preferably 60° or more and 70° or less. The center 23 overlaps a center of the irradiation unit 31 of the first line-of-sight detection unit 21, and means the center of the irradiation unit 31 of the first line-of-sight detection unit 21. The center 24 overlaps the center of the irradiation unit 31 of the second line-of-sight detection unit 22, and means the center of the irradiation unit 31 of the second line-of-sight detection unit 22. If the angle θ exceeds 70°, a detection accuracy of the line-of-sight direction 202 in the first line-of-sight detection unit 21 and the second line-of-sight detection unit 22 decreases.

Here, it is assumed that there is a center line 300C extending in the vehicle body longitudinal direction X through the viewpoint position 205.

An angle (a second angle) α formed by the first line 300R and the center line 300C centered on the viewpoint position 205 in the top view, and an angle (a third angle) β formed by the second line 300L and the center line 300C centered on the viewpoint position 205 in the top view are different from each other. If the angle θ is 70°, as an example, the angle α is 30° and the angle β is 40°. The difference between the angles α and β can be preferably 20° or less.

The first line-of-sight detection unit 21 and the second line-of-sight detection unit 22 are disposed to be offset in the vehicle body longitudinal direction X. That is, in the vehicle body longitudinal direction X, the centers 23 and 24 are at different positions, and the center 23 is closer to the driver 200 than the center 24. A difference in distance between the centers 23 and 24 in the vehicle body longitudinal direction X is less than or equal to a predetermined distance based on the position of the camera 32, and photographing ranges of the two cameras 32 and 32 of the first line-of-sight detection unit 21 can be preferably set so that a portion blocked by the steering wheel or the like is reduced in size.

As shown in FIG. 3, an airbag (a passenger seat airbag) 162 which is deployed at a predetermined timing is disposed in front of the passenger seat 142. In FIG. 4, the airbag 162 in a deployed state is indicated by a double-dotted dashed line. The second line-of-sight detection unit 22 is disposed at a position closer to the driver 200 than the outermost end 164 of the airbag 162 in the deployed state, that is, a position closer to the steering wheel 110, in the vehicle width direction Y.

A driver seat airbag 166 which is deployed at a predetermined timing is disposed at a shaft portion 112 of the steering wheel 110. Although the airbag 166 in the deployed state is not shown, the airbag 162 in the deployed state shown in FIG. 4 may be referred to. As known by referring to FIG. 1, the first line-of-sight detection unit 21 and the second line-of-sight detection unit 22 are disposed such that the first line 300R and the second line 300L are not blocked by an outermost end 111 of the steering wheel 110 and are also not blocked by the airbag 166 in the deployed state in the vehicle width direction Y.

In the vehicle body vertical direction Z, the camera 32 of the first line-of-sight detection unit 21 and the camera 32 of the second line-of-sight detection unit 22 are disposed to be offset. That is, in the vehicle body vertical direction Z, the camera 32 of the first line-of-sight detection unit 21 and the camera 32 of the second line-of-sight detection unit 22 are at different positions. The difference in height between the camera 32 below the first line-of-sight detection unit 21 and the camera 32 of the second line-of-sight detection unit 22 closer to the driver 200 is equal to or less than a predetermined distance, and can be preferably set to reduce a portion of the photographing ranges of the two cameras 32 and 32 of the second line-of-sight detection unit blocked by the steering wheel or the like.

In the vehicle body vertical direction Z, the camera 32 of the first line-of-sight detection unit 21 and the camera 32 of the second line-of-sight detection unit 22 are positioned between an upper end 133 and a lower end 134 of the side mirrors 131 and 132. At least one camera 32 can preferably be positioned between the upper end 133 and the lower end 134. In the first line-of-sight detection unit 21, only the camera 32 positioned below the irradiation unit 31 in the vehicle body vertical direction Z is positioned between the upper end 133 and the lower end 134. On the other hand, the two cameras 32 are positioned together between the upper end 133 and the lower end 134 in the second line-of-sight detection unit 22.

According to the driver's line-of-sight detection device 10-1 of the first embodiment described above, since at least the first line-of-sight detection unit 21 and the second line-of-sight detection unit 22 are disposed with the driver 200 interposed therebetween in the vehicle width direction Y in the top view, it is possible to detect the line-of-sight direction 202 with high accuracy as compared with a conventional case in which the line-of-sight detection device and the like are provided to substantially overlap with the driver 200 in the vehicle width direction Y.

According to the driver's line-of-sight detection device 10-1 of the first embodiment, since the first line-of-sight detection unit 21 and the second line-of-sight detection unit 22 are disposed in front of the steering wheel 110, a driving operation of the driver 200 is unlikely to be disturbed by the first line-of-sight detection unit 21 and the second line-of-sight detection unit 22, and is performed smoothly.

According to the driver's line-of-sight detection device 10-1 of the first embodiment, detection results of the first line-of-sight detection unit 21 and the second line-of-sight detection unit 22 can be combined by the estimation unit 36, or a detection result of one of the first line-of-sight detection unit 21 and the second line-of-sight detection unit 22, which has a higher reliability, can be adopted. As a result, the line-of-sight direction of the driver can be detected accurately and in multiple angles based on characteristics and specifications of the first line-of-sight detection unit 21 and the second line-of-sight detection unit 22 as compared with a case in which the estimation unit 36 is not provided. For example, the detection result with high reliability can be adopted from correction information obtained by removing an influence of aberration in a photographing element from image information acquired by the first line-of-sight detection unit 21 and the second line-of-sight detection unit 22.

According to the driver's line-of-sight detection device 10-1 of the first embodiment, since the first line-of-sight detection unit 21 is disposed in the front pillar 113, it is possible to detect whether the driver 200 has viewed the side mirror 131 with high accuracy. In addition, according to the driver's line-of-sight detection device 10-1 of the first embodiment, the first line-of-sight detection unit 21 is disposed not to protrude from the front pillar 113, and thereby wiring efficiency of the first light-of-sight detection unit 21 can be increased.

According to the driver's line-of-sight detection device 10-1 of the first embodiment, the second line-of-sight detection unit 22 is disposed at a position closer to the passenger seat 142 than the steering wheel 110 in the vehicle width direction Y. For this reason, the line of sight of the driver 200 is unlikely to be blocked by the steering wheel 110, and it is possible to prevent the infrared rays from the irradiation unit 31 of the second line-of-sight detection unit 22 from being blocked by the steering wheel 110 and to prevent the camera 32 of the second line-of-sight detection unit 22 from not being able to capture an eyeball image or a part of the eyeball image from being lost. As a result, the infrared rays from the irradiation unit 31 of the second line-of-sight detection unit 22 can be delivered to the eyeball 210 well, the camera 32 can capture the eyeball 210 and the reference point well, and the line-of-sight direction 202 can be detected with high accuracy.

According to the driver's line-of-sight detection device 10-1 of the first embodiment, since the second line-of-sight detection unit 22 is provided in the upper end portion (around the display unit) of the support unit 118 when viewed in the vehicle body longitudinal direction X, it is possible to detect with high accuracy whether the driver 200 has viewed the display unit 150. Moreover, according to the driver's line-of-sight detection device 10-1 of the first embodiment, the second line-of-sight detection unit 22 is disposed not to protrude from the support unit 118, and thereby the wiring efficiency of the second light-of-sight detection unit 22 can be increased.

According to the driver's line-of-sight detection device 10-1 of the first embodiment, the second line-of-sight detection unit 22 is disposed between the driver's seat 141 and the passenger seat 142 in the vehicle width direction Y. For this reason, the line of sight of the driver 200 is unlikely to be blocked by the steering wheel, a passenger sitting on the passenger seat, or the like, and the line-of-sight direction 202 can be detected with high accuracy. In addition, according to the driver's line-of-sight detection device 10-1 of the first embodiment, the second line-of-sight detection unit 22 can be disposed in a wide installation space common to the display unit 150, the operation unit, and the like in the vehicle width direction Y between the driver's seat 141 and the passenger seat 142, and thereby an installation space of the second line-of-sight detection unit 22 can be easily ensured.

According to the driver's line-of-sight detection device 10-1 of the first embodiment, since the angle θ is 60° or more and 70° or less, an entire detectable range of the line-of-sight direction 202 by the first line-of-sight detection unit 21 and the second line-of-sight detection unit 22 can be ensured widely in the azimuth angle direction R as compared with a conventional case in which one line-of-sight detection unit is provided.

According to the driver's line-of-sight detection device 10-1 of the first embodiment, since the angles α and β are different from each other, in the azimuth angle direction R, the detection angle range of the first line-of-sight detection unit 21 and the detection angle range of the second line-of-sight detection unit 22 can be appropriately distributed in the azimuth angle direction R without waste. By devising and utilizing the detection angle ranges of the first line-of-sight detection unit 21 and the second line-of-sight detection unit 22 in the azimuth angle direction R, even if the detection range of the line-of-sight direction 202 is wide in the azimuth angle direction R, it is possible to detect the line-of-sight direction 202 over a wide angle with high accuracy, and evenly in the azimuth angle direction R.

According to the driver's line-of-sight detection device 10-1 of the first embodiment, the first line-of-sight detection unit 21 and the second line-of-sight detection unit 22 are disposed to be offset in the vehicle body longitudinal direction X, and thus, the detection angle range of the first line-of-sight detection unit 21 and the detection angle range of the second line-of-sight detection unit 22 can be appropriately and widely distributed without waste in the vehicle body longitudinal direction X. By devising and utilizing the detection angle ranges of the first line-of-sight detection unit 21 and the second line-of-sight detection unit 22 in the vehicle body longitudinal direction X, the detection range of the line-of-sight direction 202 is wide in the vehicle body longitudinal direction X, the line-of-sight direction 202 can be detected with high accuracy and evenly in the vehicle body longitudinal direction X.

According to the driver's line-of-sight detection device 10-1 of the first embodiment, the second line-of-sight detection unit 22 is disposed at a position closer to the driver 200 than the outermost end 164 of the airbag 162 in the deployed state in the vehicle width direction Y. Therefore, even when the airbag 162 is deployed, the line of sight of the driver 200 reaches the second line-of-sight detection unit 22 without being blocked by the airbag 162 in the deployed state, infrared rays from the irradiation unit 31 of the second line-of-sight detection unit 22 are delivered to the eyeball 210 well, the eyeball 210 and the reference graphic are captured well by the camera 32, and thereby it is possible to detect the line-of-sight direction 202 with high accuracy.

According to the driver's line-of-sight detection device 10-1 of the first embodiment, the line-of-sight detection units 12 include the irradiation unit 31 and the camera 32, respectively. Therefore, the position of the iris 212 in the eyeball 210 of the driver 200 can be detected by the line-of-sight detection unit 12 with high accuracy, and the line-of-sight direction 202 independent of a direction of the face of the driver 200 can be accurately detected.

According to the driver's line-of-sight detection device 10-1 of the first embodiment, the irradiation unit 31 and the camera 32 of the first line-of-sight detection unit 21 can be disposed to fit well in the front pillar 113 or the like in the vehicle body vertical direction Z.

According to the driver's line-of-sight detection device 10-1 of the first embodiment, the irradiation unit 31 and the camera 32 of the second line-of-sight detection unit 22 can be disposed to fit well in the upper end portion and the lower end portion of the support unit 118 in the vehicle width direction Y.

According to the driver's line-of-sight detection device 10-1 of the first embodiment, since the camera 32 of the first line-of-sight detection unit 21 and the camera 32 of the second line-of-sight detection unit 22 are disposed to be offset in the vehicle body vertical direction Z, the detection angle range of the first line-of-sight detection unit 21 and the detection angle range of the second line-of-sight detection unit 22 can be appropriately and widely distributed without waste in the vehicle body vertical direction. By devising and utilizing the detection angle ranges of the first line-of-sight detection unit 21 and the second line-of-sight detection unit 22 in the vehicle body vertical direction Z, the detection range of the line-of-sight direction 202 is wide in the vehicle body vertical direction Z, and the line-of-sight direction 202 can be detected with high accuracy and evenly in the vehicle body vertical direction Z.

According to the driver's line-of-sight detection device 10-1 of the first embodiment, since the camera 32 of the first line-of-sight detection unit 21 and the camera 32 of the second line-of-sight detection unit 22 are positioned between the upper end 133 and the lower end 134 of the side mirrors 131 and 132 in the vehicle body vertical direction Z, it is possible to detect with high accuracy whether the driver 200 has viewed the side mirror 131, and to provide an appropriate driving support to the driver 200.

### Second Embodiment

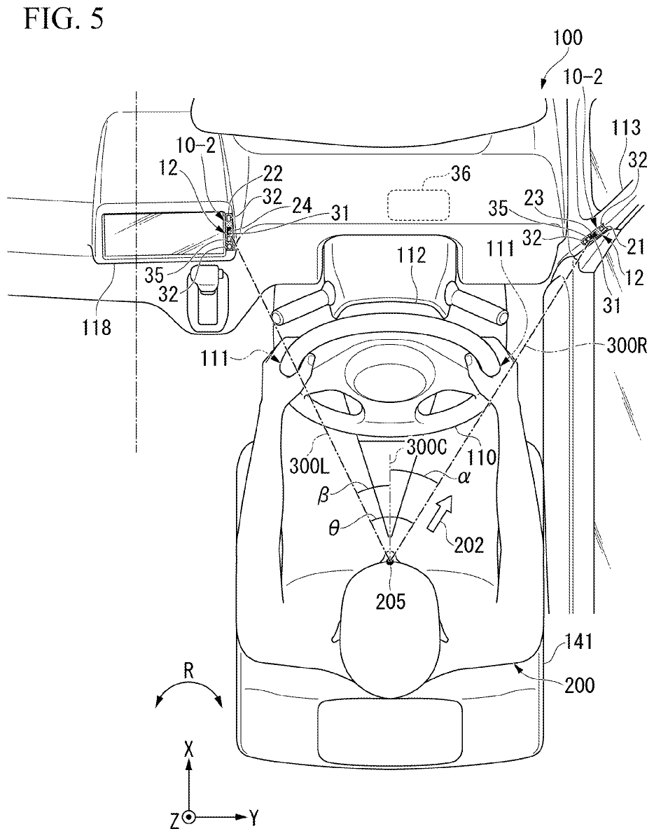

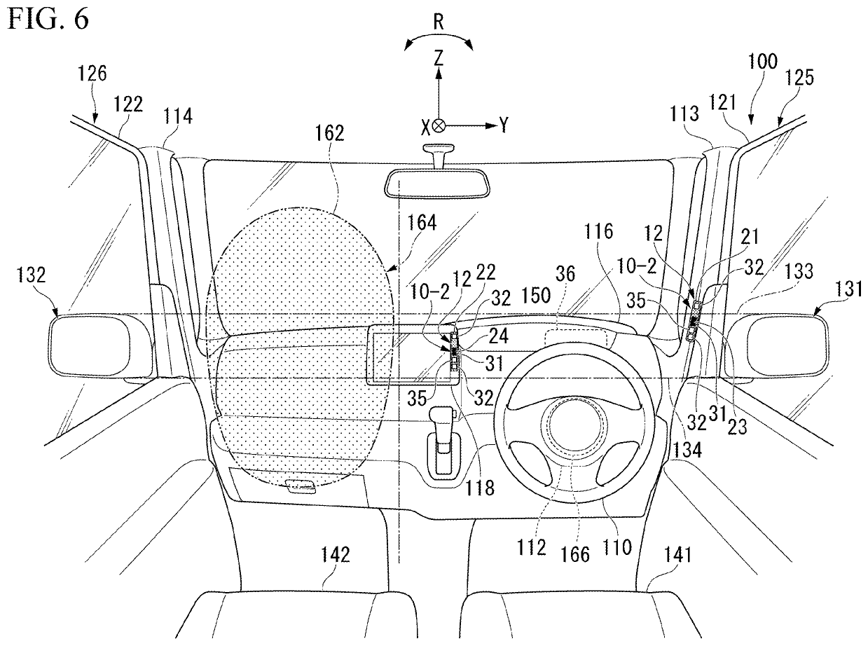

Next, a driver's line-of-sight detection device (a driver state detection device) 10-2 according to a second embodiment of the present invention will be described. In the following description, description of constituents of the driver's line-of-sight detection device 10-2 common to those of the driver's line-of-sight detection device 10-1 will be omitted and constituents of the driver's line-of-sight detection device 10-2 different from those of the driver's line-of-sight detection device 10-1 will be described. In FIGS. 5 and 6, each constituent of the driver's line-of-sight detection device 10-2 common to that of the driver's line-of-sight detection device 10-1 will be denoted by the same reference numeral as a corresponding one in the driver's line-of-sight detection device 10-1.

As shown in FIGS. 5 and 6, in the driver's line-of-sight detection device 10-2, the second line-of-sight detection unit 22 is provided around the display unit 150 when viewed in the vehicle body longitudinal direction X, and in the support unit 118 adjacent to a right side edge of the display unit 150. In the second line-of-sight detection unit 22, the irradiation unit 31 and the two cameras 32 and 32 are disposed in the vehicle body vertical direction Z, and the camera 32, the irradiation unit 31 and the camera 32 are disposed at intervals in this order from the upper side to the lower side.

In the driver's line-of-sight detection device 10-2, the angle θ can be preferably 70° or less, can be more preferably 60° or more and 70° or less, and can be further preferably 60°. The angles α and β are equal to each other. If the angle θ is 60°, the angles α and β are both 30°. However, if a difference between the angles α and β is, for example, about 1°, and an image acquisition condition, distortion, and the like of the camera 32 at the time of photographing do not affect the estimation or detection of the line-of-sight direction 202, it is assumed that the angles α and β are equal to each other.

According to the driver's line-of-sight detection device 10-2 of the second embodiment described above, the driver's line-of-sight detection device 10-2 has constituents common to the driver's line-of-sight detection device 10-1 which can obtain the same effects as in the driver's line-of-sight detection device 10-1.

In addition, according to the driver's line-of-sight detection device 10-2 of the second embodiment, since the second line-of-sight detection unit 22 is provided on a side end portion of the support unit 118 (around the display unit) when viewed in the vehicle body longitudinal direction X, it is possible to detect with high accuracy whether the driver 200 has viewed the display unit 150 similarly to the driver's line-of-sight detection device 10-1 of the first embodiment. Moreover, according to the driver's line-of-sight detection device 10-2 of the second embodiment, the second line-of-sight detection unit 22 is disposed not to protrude from the support unit 118, and thereby the wiring efficiency of the second line-of-sight detection unit 22 can be increased.

Furthermore, according to the driver's line-of-sight detection device 10-2 of the second embodiment, since the center 24 of the second line-of-sight detection unit 22 is offset to the driver 200 side from a center of the display unit 150 when viewed in the vehicle body longitudinal direction X, it is easier to detect whether the driver 200 has viewed the display unit 150 as compared with a case in which the second line-of-sight detection unit 22 is provided in the upper end portion of the support unit 118. Furthermore, according to the driver's line-of-sight detection device 10-2 of the second embodiment, the second line-of-sight detection unit 22 can be disposed away from the airbag 162 in the vehicle width direction Y as compared with the case in which the second line-of-sight detection unit 22 is provided in the upper end portion of the support unit 118.

In addition, according to the driver's line-of-sight detection device 10-2 of the second embodiment, since the angles α and β are equal to each other, accuracies of detection visual fields of the first line-of-sight detection unit 21 and the second line-of-sight detection unit 22 can be made equal to each other on right and left sides centered on the center line 300C. Moreover, by devising and utilizing the detection angle ranges of the first line-of-sight detection unit 21 and the second line-of-sight detection unit 22 in the azimuth angle direction R, even if the detection range of the line-of-sight direction 202 is wide in the azimuth angle direction R, it is possible to detect the line-of-sight direction 202 over a wide angle with high accuracy, and evenly in the azimuth angle direction R.

Moreover, according to the driver's line-of-sight detection device 10-2 of the second embodiment, since the two cameras 32 and 32 of the second line-of-sight detection unit 22 are disposed in the vehicle body vertical direction Z, and the angles α and β are equal to each other, a detection accuracy of the line-of-sight direction 202 in the vehicle body vertical direction Z can be increased. As a result, it is possible to increase the detect accuracy of the line-of-sight direction 202 by distinguishing, for example, whether the driver 200 is viewing the side mirror 131, a background above the side mirror 131, a passerby, or the like.

Although preferred embodiments of the present invention have been described in detail above, the present invention is not limited to the embodiments described above. The present invention can be changed within the scope of the gist of the present invention set forth in the claims.

For example, the irradiation unit 31 and the camera 32 of the first line-of-sight detection unit 21 may be directly embedded in a predetermined area of the front pillar 113 in the vehicle body vertical direction Z. Similarly, the irradiation unit 31 and the camera 32 of the second line-of-sight detection unit 22 may be directly embedded in the support unit 118 adjacent to the upper end edge of the display unit 150 in the vehicle width direction Y.

For example, the display unit 150 may be detachable from the support unit 118. For example, a smartphone may be installed in the support unit 118 as the display unit 150. In this case, the second line-of-sight detection unit 22 may be disposed not to be hidden by a smartphone but to be exposed when viewed from the rear to the front in the vehicle body longitudinal direction X. Moreover, the support unit 118 may be capable of being accommodated inside the dashboard 116.

For example, the second line-of-sight detection unit 22 may be provided in the support unit 118 adjacent to the lower end edge or the side end edge other than the upper end edge of the display unit 150, or in the vicinity of the side end edge or the lower end edge. When the second line-of-sight detection unit 22 is provided in the support unit 118 around the side end edge of the display unit 150, the irradiation unit 31 and camera 32 of the second line-of-sight detection unit 22 are disposed at intervals in the vehicle body vertical direction Z. When the second line-of-sight detection unit 22 is provided in the support unit 118 around the lower end edge of the display unit 150, the irradiation unit 31 and camera 32 of the second line-of-sight detection unit 22, similar to the embodiment described above, are disposed at intervals in the vehicle width direction Y.

For example, the second line-of-sight detection unit 22 may be disposed in a member of the vehicle 100 or the dashboard 116 other than the support unit 118, and may also be disposed in an operation unit between the driver's seat 141 and the passenger seat 142 in the vehicle width direction Y. In this case, in consideration of relative disposition of the operation unit with respect to various operation members, the irradiation unit 31 and the camera 32 of the second line-of-sight detection unit 22 are disposed at intervals in the vehicle width direction Y or vehicle body vertical direction Z in an area in which their wiring efficiency does not have to decrease.

Moreover, the line-of-sight detection unit 12 is not necessarily limited to one including two irradiation units 31 and one camera 32, and is not particularly limited as long as the line-of-sight direction 202 can be detected regardless of the rotation or direction of the head of the driver 200. For example, the line-of-sight detection unit 12 may include one irradiation unit 31 and one camera 32, or may include only the camera 32 if the line-of-sight direction 202 can be detected.

In addition, in the line-of-sight detection unit 12, a portion of the iris 212 is photographed and detected by the camera 32, and a distance between the iris 212 and a portion of the eye other than the iris 212 is measured, and thereby the line-of-sight direction 202 may be detectable only using an image acquired by the camera 32. That is, the line-of-sight detection unit 12 may include only the camera 32.

Further, in the first and second embodiments described above, the driver's line-of-sight detection devices 10-1 and 10-2 capable of detecting the line-of-sight direction 202 of the driver 200 are shown as a driver state detection device, but the driver state detection device of the present invention is not limited to the driver's line-of-sight detection devices. Examples of the driver state detection device of the present invention other than the driver's line-of-sight detection devices include, for example, a device capable of detecting a direction of the head of the driver 200 and a device capable of detecting a vibration speed and a vibration direction of the head of the driver 200. The device capable of detecting the direction of the head of the driver 200 and the device capable of detecting the vibration speed and the vibration direction of the head of the driver 200 can include the same constituents as the driver's line-of-sight detection devices 10-1 and 10-2. In this case, the line-of-sight detection unit 12, the first line-of-sight detection unit 21, and the second line-of-sight detection unit 22 are set as a state detection unit, a first state detection unit, and a second state detection unit, respectively, and each state detection unit may be given a function of detecting the direction of the head of the driver 200 or a function of detecting the vibration speed and the vibration direction of the head of the driver 200. Specifically, the camera 32, the image analysis unit 35, and the estimation unit 36 may be given the function of detecting the direction of the head of the driver 200, or the function of detecting the vibration speed and vibration direction of the head of the driver 200.

According to the driver state detection device capable of detecting the direction of the head of the driver 200, it is possible to detect or predict side-view driving with high accuracy and at an early stage by, for example, measuring a length of time when the driver 200 is not looking at the front or the side mirror 131. According to the driver state detection device capable of detecting the vibration speed and the vibration direction of the head of the driver 200, for example, it is possible to detect a degree of concentration of the driver 200 on driving, a degree of excitement of the driver 200, and the like with high accuracy. These driver state detection devices can provide an appropriate driving assistance to the driver 200 on the basis of the detection results.

What is claimed is:

1. A driver state detection device comprising:
at least two state detection units that include a first state detection unit and a second state detection unit that detect a state of a driver of a vehicle,
wherein the first state detection unit and the second state detection unit are disposed at positions between which the driver is interposed in a vehicle width direction, and
the first state detection unit and the second state detection unit are disposed in front of a rear end of a driver's seat.

2. The driver state detection device according to claim 1,
wherein the state detection units are at least two line-of-sight detection units that include a first line-of-sight detection unit and a second line-of-sight detection unit that detect a line-of-sight direction of the driver.

3. The driver state detection device according to claim 2,
wherein the first line-of-sight detection unit and the second line-of-sight detection unit are disposed in front of a steering wheel.

4. The driver state detection device according to claim 2, comprising:
an estimation unit configured to estimate the line-of-sight direction of the driver based on a detection result of the line-of-sight detection unit.

5. The driver state detection device according to claim 2,
wherein in the vehicle,
a window frame is disposed on a side of the driver,
a mirror is disposed on an outer side of the window frame in the vehicle width direction, and
a front pillar extending in a vehicle body vertical direction is disposed in front of the window frame, and
wherein the first line-of-sight detection unit is disposed on the front pillar.

6. The driver state detection device according to claim 2,
wherein the vehicle comprises a driver's seat on which the driver is seated, and a passenger seat disposed on a side of the driver's seat, and
the second line-of-sight detection unit is disposed at a position closer to the passenger seat side than a steering wheel in the vehicle width direction.

7. The driver state detection device according to claim 2,
wherein the vehicle comprises a display unit configured to display a preference image, a situation of an interior space of the vehicle, or a situation of surroundings of the vehicle, and
the second line-of-sight detection unit is provided around the display unit.

8. The driver state detection device according to claim 7,
wherein the display unit is disposed between the driver's seat and the passenger seat in the vehicle width direction.

9. The driver state detection device according to claim 2,
wherein a first angle formed of a first line connecting a center of the first line-of-sight detection unit and a viewpoint position of the driver and a second line connecting a center of the second line-of-sight detection unit and the viewpoint position in a top view is equal to or less than 70°.

10. The driver state detection device according to claim 9,
wherein the first angle is equal to or more than 60°.

11. The driver state detection device according to claim 9,
wherein a second angle, which is formed of the first line centered on the viewpoint position and a center line extending in a vehicle body longitudinal direction through the viewpoint position in the top view, and a third angle, which is formed of the second line and the center line in the top view, are different from each other.

12. The driver state detection device according to claim 9,
wherein a second angle, which is formed of the first line centered on the viewpoint position and a center line extending in a vehicle body longitudinal direction through the viewpoint position in the top view, and a third angle, which is formed of the second line and the center line in the top view, are equal to each other.

13. The driver state detection device according to claim 2,
wherein the first line-of-sight detection unit and the second line-of-sight detection unit are disposed to be offset in a vehicle body longitudinal direction.

14. The driver state detection device according to claim 6,
wherein a passenger seat airbag that is deployed at a predetermined timing is disposed in front of the passenger seat in a vehicle body longitudinal direction, and
the second line-of-sight detection unit is disposed at a position closer to the driver side than an outermost end of the passenger seat airbag in a deployed state in the vehicle width direction.

15. The driver state detection device according to claim 2,
wherein each of the at least two line-of-sight detection units comprises
an irradiation unit configured to irradiate the driver with a reference point, and
a recognition unit configured to recognize the reference point and a part of an eyeball of the driver,
wherein the irradiation unit and the recognition unit are disposed in a vehicle body vertical direction in the first line-of-sight detection unit.

16. The driver state detection device according to claim 15,
wherein the irradiation unit and the recognition unit are disposed in the vehicle width direction in the second line-of-sight detection unit.

17. The driver state detection device according to claim 15,
wherein the irradiation unit and the recognition unit are disposed in the vehicle body vertical direction in the second line-of-sight detection unit.

18. The driver state detection device according to claim 15,
wherein the recognition unit of the first line-of-sight detection unit and the recognition unit of the second line-of-sight detection unit are disposed to be offset in the vehicle body vertical direction.

19. The driver state detection device according to claim 15,
wherein the recognition unit of the first line-of-sight detection unit and the recognition unit of the second line-of-sight detection unit are disposed between an upper end and a lower end of a mirror in the vehicle body vertical direction.
